(19) United States
(12) Patent Application Publication
(10) Pub. No.: US 2025/0103818 A1
(43) Pub. Date: Mar. 27, 2025

(54) HALLUCINATION DETECTION AS A METRIC FOR DETERMINING ACCURACY OF RESULTS FOR LARGE LANGUAGE MODELS IN MACHINE LEARNING

(71) Applicant: Bitvore Corp., Los Angeles, CA (US)

(72) Inventors: Gregory Alan Bolcer, Yorba Linda, CA (US); Rodrigo Silva Nader, Uberlândia (BR); Gabriel Luiz Freitas Almeida, Ribeirão Preto (BR)

(21) Appl. No.: 18/471,513

(22) Filed: Sep. 21, 2023

(51) Int. Cl. G06F 40/30; G06F 16/33; G06F 16/332; G06F 40/279

(52) U.S. Cl. CPC G06F 40/30; G06F 16/3328; G06F 16/3344; G06F 40/279

(57) ABSTRACT

This disclosure describes detecting hallucination as a metric for determining the accuracy of responses from a large language model (LLM). Scores with and without an augmented system are compared. The similarity or dissimilarity may be mapped into a hallucination score. The hallucination score can accurately predict when an answer is likely to be a hallucination. This is accomplished using similarity analysis on the text between un-altered responses and altered responses.

### BACKGROUND

Limitations and disadvantages of large language models that generate results with a limited accuracy will become apparent to one of skill in the art, through comparison of such approaches with some aspects of the present method and system set forth in the remainder of this disclosure with reference to the drawings.

### BRIEF SUMMARY

Systems and methods are provided for detecting hallucination as a metric for determining the accuracy of responses from a large language model, substantially as illustrated by and/or described in connection with at least one of the figures, as set forth more completely in the claims.

### BRIEF DESCRIPTION OF THE DRAWINGS

FIG. 1 illustrates an example systems for detecting hallucination as a metric for determining the accuracy of responses from a large language model, in accordance with various example implementations of this disclosure.

FIG. 2 illustrates another example systems for detecting hallucination as a metric for determining the accuracy of responses from a large language model, in accordance with various example implementations of this disclosure.

### DETAILED DESCRIPTION

A large language model (LLM) is a type of artificial intelligence (AI) that is trained on large amounts of text data and can generate new text based on that training. LLM is a broad term that encompasses a variety of models, including those used for natural language generation.

This disclosure provides a system and method for using natural language processing (NLP) of text to determine a likelihood that a prompt to an LLM will result in a response from the LLM that is factually untrue. The system and method also use NLP of text to determine a likelihood that a response from an LLM is factually untrue, regardless of the prompt.

A prompt refers to the first input given to a language model. A prompt may take the form of questions, tasks, instructions, or a series of answers and responses either by the user or by another system. A prompt template may contain instructions to guide the language model, a set of few-shot examples to help the language model generate a better response, and/or specific questions directed at the language model.

A prompt is the natural language pattern used to instruct the LLM how to respond. Prompts can be questions, tasks, instructions, or a series of answers and responses either by the user or a similar series by other users and agents. Workflows may comprise various parts chained together.

Prompt engineering is the manner in which how things are described, written, expressed, changed or augmented with additional context and information such that the LLM returns better, more relevant results. Prompt engineering may include, by way of example and not limitation, weighting individual terms positively or negatively, given more recent conclusions, context, or examples, or being more general or more descriptive to guide the generative content.

In an alternate implementation, a prompt instead of being a natural language pattern to be submitted to a text-generative LLM, could be a data query. The results of the data query would then be used, not as a rewritten prompt, but a real-time, ad hoc fine-tuning training set of a small corpus of text, metadata, and reference data. This fine-tuning set can then either be used with the original prompt or a rewritten prompt.

Data Query Language (DQL) is a type of computer language that is used to request, manipulate and/or otherwise interact with data in databases and information systems. Some examples are Cypher, SQL, and SparkQL.

A hallucination is the resulting content from the LLM such that the generated content is nonsensical, unfaithful to the provided source content, training material, or fine-tuned data set. Hallucinations may also be believable, but objectively false as compared to a grounded truth that is salient to the concepts and entities in the response.

As disclosed, a similarity analysis is applied using word vectors to determine the types of prompts and responses that are likely to lead to unreliable results. A result that structurally makes sense in terms of language but contradicts current information or reference data is called a hallucination in the field of machine learning and NLP. As disclosed, NLP techniques are used to generate a score according to how likely a prompt will lead to a hallucination or how likely a result is a hallucination. According to this score, other automated systems may augment the system with additional information or data. For example, the LLM may need additional information if the training set is insufficient or if more recent data contradicts previous fine-tuning information. The hallucination score may indicate that the system requires additional data. The hallucination score may also indicate that the results are untruthful and that a request or a result should be reformulated.

The disclosed system and method may prevent hallucinations by augmenting the prompt and results by providing up-to-date information at different points in a series of sequential and recursive calls to the model. The process for analyzing real-time news text may be used for analyzing prompts and results.

GPT models rely on the knowledge they gain after the models are trained with hundreds of billions of parameters on massive language datasets. Even though new training samples appear, the information from previous learning remains. New information may be weighted relative old information. New evidence is required to deny previous beliefs. A change in beliefs may require a very reliable source and/or evidence from multiple sources in different contexts.

LLMs have revolutionized the field of NLP, enabling remarkable advances in text generation, question answering, and data analysis. However, as these models become increasingly powerful, there arises a significant concern regarding the generation of inaccurate or false information. An LLM is susceptible to hallucinations, where the LLM generates text that appears plausible but lacks factual basis or is entirely fabricated.

The problem with hallucinations arises due to the nature of LLMs, which are trained, on vast amounts of text data, to learn patterns, grammar, and context. While LLMs excel at generating coherent and contextually appropriate responses, LLMs lack a comprehensive understanding of the real world and the ability to verify the accuracy of the information produced.

Also, the inherent nature of pre-training LLMs limits the LLMs' knowledge of real-time events, time-sensitive information, and dynamically changing contexts. As a result, when faced with queries that involve time-related constraints or other constraints, LLMs may generate responses that are outdated or otherwise inaccurate in a manner not related to time. This phenomenon poses a challenge in applications where up-to-date information is crucial, especially in cases where current information contradicts historical facts or carries more weight than training data.

The generation of inaccurate information can have severe consequences for individuals and organizations when making decisions based on unreliable outputs. Consequently, there is a need to develop techniques and methodologies to mitigate this issue and ensure the generation of truthful responses by LLM search-based systems.

This disclosure describes a system and method for handling natural language queries, retrieving relevant information from a database, and validating generated answers. The process leverages recursive calls to LLMs with specialized prompts and employs vector embeddings to improve the accuracy of information retrieval tasks.

A process of converting natural language queries into structured data queries is disclosed herein. A similarity-based approach for truthfulness validation is also disclosed. This disclosure provides detailed descriptions of the individual components and an example comparing the traditional approach with the proposed solution.

The disclosed system integrates advanced technologies in a unique way, resulting in improved natural language query interpretation and structured data querying. The disclosed system uses LLMs, prompted language models, and similarity-based validation techniques. The disclosed system is capable of estimating if LLMs will fail and become hallucinatory. This determination utilizes similarity-based validation, high-precision reference data accessed through agent workflows, time-ordering of information, and a hallucination score. The hallucination score is based on factors including the entities involved, the context, metadata, and the model's awareness of new information. This approach enhances the reliability of LLMs in various applications.

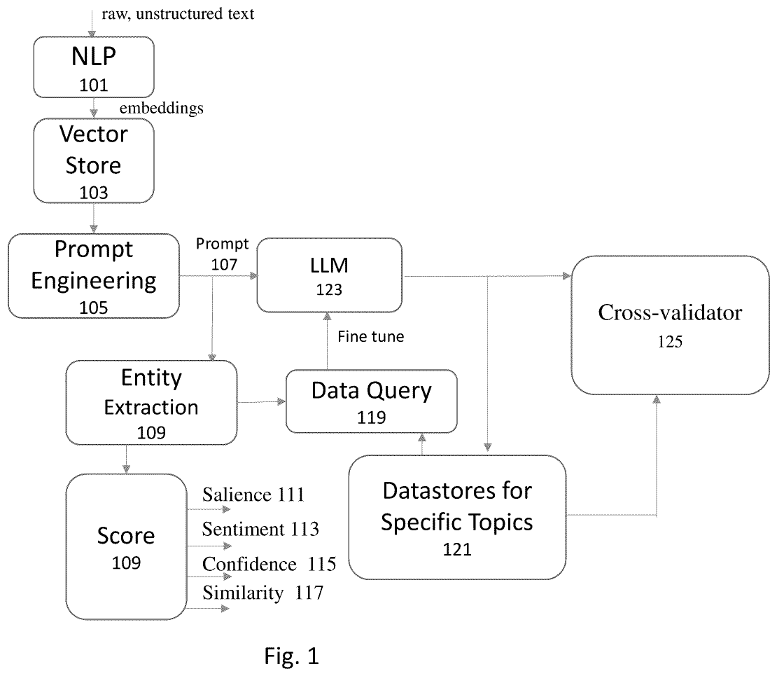

FIG. 1 illustrates an example systems for detecting hallucination as a metric for determining the accuracy of responses from a large language model, in accordance with various example implementations of this disclosure.

Truthfulness is validated according to a similarity score and a database, such as a vector store (e.g., VQL). NLP 101 converts pieces of raw, unstructured text into embeddings. A vector [data]store 103 is a data structure that stores vectors, which are embeddings or other representations of text or other data. It allows for efficient similarity searches and other operations. The vector datastore 103 stores the embeddings of texts. Embeddings are relatively low-dimensional correlations that may represent word or phrase closeness to other words or phrases. Similarity analysis, via AI-assisted prompt engineering 105, leverages the embeddings.

The prompts 107 may be converted into a theoretical “premise” about what the expected result should be based on entity extraction 109 of people, companies, and topics as well as scores based around how important (salience) 111 or positive or negative (sentiment) 113 or how accurate (confidence) 115 we are for each entity. Each and every prompt a user or computer inputs can be compared with all previous prompts and scored on similarity 117.

Alternatively, instead of performing AI-assisted prompt engineering 105, all of the entities and metrics may be extracted 109 to generate an automated data query 119. The automated data query 119 may use any number of various databases and datastores 121 for specific topics. The automated data query 119 may return a number of real-time, timestamped, natural language text, semi-structured records, reference data, scores, metrics, or embeddings and similarity scores. This culmination of data can be used to fine-tune any LLM 123 to provide more truthful answers based on known information instead of re-writing the prompt. In either case, the effects are the same.

A list of known relationships and reference data and topics may be extracted 101 from the raw text. In the case of prompt rewriting 105, the key concepts may be pulled out using current techniques, and some number of samples are generated that preserve the meaning. Each sample may contain slightly different wording. Each sample is then scored 109 against a known vector datastore 103 of previous prompts that are known to trigger hallucinations or return good results. Or in the case of the second approach, a query 119 across all known databases 121 may be issued using the same entities, topics, and metrics.

An augmented output may be cross-validated 125 across various datastores 121 to check for consistency with other LLM output having the same entities, topics and/or metrics. Analysis may eliminate or flag pieces for which there is no supporting data or conflicting data.

In the case where there is no supporting data in the vast datastore 121, assessments can be time split. If supporting data were to suddenly appear, there would be an explicitly timestamped piece of data either in the datastore 121 (like a timestamped news stream) or reference data such that previous to that timestamp, there would be no evidence or contradictory evidence, and after that there would be.

Traditional similarity scoring including embeddings is commonly practiced in NLP. Extracting the entities, topics and metrics, in effect doing a conceptual summary, can be fed back into a generative AI system 123 while preserving the original meaning. In essence an LLM 123 or rule-based system can convert the prompt 107 into a new prompt, which also can be scored and ranked according to similarity to other successful prompts or in the second case, converted to a multi-database collection query to be used as a LLM fine tuning training set. There are multiple LLMs and fine-tuned LLMs that can be leveraged. For example, OpenAI's GPT, LLAMA, Alpcaca, and dozens of others, both domain specific and not, are available.

The ability to leverage data selectively through a vector datastore 121 improves the quality of questions and answers that the data can provide. The capabilities of the vector datastore 103 are turned into AI-assisted prompts 107 and premises about what is in the data. Cross-checking 125 validates the answers that come out.

Our data includes specific, high precision, analysis of the NLP data 101 that is validated against customer needs. Also, it includes various high quality entities, reference data, topics, and metrics that are pre-computed. This pre-analysis and AI-ready data completely changes what is possible for making LLM-generated content truthful. Other models can be the whole ensemble of models used in an analysis chain, including entity extraction, topics, and metrics.

A task to rewrite text may be given to an LLM 123 with or without fine-tuning. In the case where the prompt 107 is not rewritten, but turned into a cross-database query 119, the results are then used in real-time to create an ad-hoc NLP model for use w/the premise and answer. In certain cases where a workflow to derive an answer requires a sub-goal that cannot be satisfied by an automated process, a human-in-the-loop might be required. Human-in-the-loop AI systems are a well-known practice in data science and AI training. Sub-goals are not human-generated unless a human-in-the-loop requires ideas on how to solve a problem.

The resulting text may be analyzed using an NLP pipeline. Using that extracted and enriched information, similarity analysis may use a vector datastore 121 of known hallucinations and good answers. By using other metrics like saliency 111 (i.e., how important answer is against original prompt or topic or entity), the system can determine by the hallucination score whether parts of the text need to be excised, improved/iterated on to improve or re-generate the answers. All may require either a rule-based approach, a human-rewrite, or another specific round of AI generated text using specific sub-sections.

By way of example and not limitation, a large-scale, high-speed content storage and analysis platform, such as the platform produced by Bitvore, may effectively process the world's business news, by running it through a series of AI and text processing modules to convert unstructured text into annotated, semi-structured text. These annotations include spatial vector data, and other data, and are indexed and stored. Using a query language, content can be found using tag names, tag values, phrases, raw text, scores, similarity, categorization, and multiple other techniques.

In this example database structure/system, each record has a unique identifier called a rowkey. In other database architectures there may be other identifiers. Any entities that are reliably determined to be salient to the article are extracted and put into tags. There are metadata tags like the article type, source URL, title, published data, and others. The models comprise pull out signals which indicate situations described in the unstructured text that are predicted to have a financial impact on a company or municipality.

In this example system, signals or topics have their own taxonomy that cover business issues, environmental, social, and governance issues with a material impact on the entity. For instance, a BusinessRisk signal can be specified as: Business. BusinessRisk. CompetitiveRisk if the text is found to represent a competitive risk to the company. In other systems there may be non-business information or any other type of information including non-textual information.

By way of example and not limitation, other annotated data generated from the AI analysis of the text may comprise: broad economic themes, similarity clustering links to other articles (or collections of information), key phrases, geographical locations, industries and industry taxonomy (economic sector, business sector, industry group), relationships between entities (competitor-with, investor-in, employee-of), financial topics, and people. Each type of entity that is identified also has scores either aggregated for the whole article (or other collection of information) or on a per-mention basis. The scores may comprise: sentiment 113 (positive or negative), salience 111 (how important to the whole article), confidence 115 (how sure that the entity is correctly identified), co-references (for example, “the company” represents Tesla in this article about electric vehicles, etc), disambiguation (score against competing interpretations), and similarity 117 (score for how similar content is to all other content in the system). For avoidance of confusion, an article is defined as a collection of information including but not limited to a news article or other collection of textual or non-textual information.

The storage of this annotated data provides a real-time data stream available for production AI models and for applications and other AI models built on the data. In addition to dynamically generated tags and values on the content, the AI models use reference data or other kinds of data to help guide the specific results and scoring.

Companies, people, and industries have real-time scores associated with them across a time period. The scores are stored in a vector store 121, and are available to the AI models evaluating the text. Sentiment scores 113 are averaged or weighted averaged for every mention or article or can be calculated on a per-mention basis. Risk scores comprise derived sentiment 113 from signal tags that increase or decrease the risk for the company. Growth scores comprise derived sentiment 113 from signal tags that increase or decrease the growth potential of the company. Environmental, Social, or Governance scores are derived from sentiment from ESG signal tags.

A list of all companies and municipalities or other entities/objects/things may be stored for use by the AI models. These include, but are not limited to, the following tags for use: Id—Bitvore ID that uniquely identifies the company, Name—Name of the company, Ticker—Ticker the company is traded under (if public), MIC—MIC code of the exchange the ticker is traded on, DomainName—Website domain name of the company, City—City the company's headquarters is located in, State—State code of the state the company's headquarters is located in, Country—Country the company's headquarters is located in, Employees—Number of employees for the company within a range (the ranges may be 1-10, 10-50, 50-100, 100-250, 250-500, 500-1000, 1000-5000, 5000-10000, >10000), NAICSIndustry—NAICS industry code for the industry the company primarily operates in, SICIndustry—SIC industry code for the industry the company primarily operates in, YearFounded—Year the company was founded, FacebookUrl—URL of the company's Facebook page, LinkedInUrl—URL of the company's LinkedIn page, TwitterUrl—URL of the company's Twitter page, ParentId—Bitvore ID that uniquely identifies the company's immediate parent (if any), UltimateParentId—Bitvore ID that uniquely identifies the company's ultimate (root) parent (if any), LastModified—The date a record was last changed as yyy-MM-dd hh:mm.

Conceptual comparison, via access to the real-time annotated feed, or other source of information or data, in a format that is compatible with both internal AI models and external AI models, may reduce hallucinations by providing the most up to date information. Conceptual comparison may comprise, for example, collecting tags from queries/sub-queries and using them as reference in a prompt for the model.

Access to authoritative reference data, especially about the entities identified in the prompt, result, or intermediate results collected from sub-queries or solving sub-goals, may generate a more accurate, truthful or more useful answer due to the additional information.

A user's prompt can be checked 109 for known entities. Likewise, if the user's prompt is determined to be related to an industry, person, or a signal, the system can generate a query 119 to determine if any new information exists, how much new information relevant to the prompt is in the real-time store, and whether the new information is conceptually relevant or relevant in some other way to the prompt. The prompt can also be evaluated 109 for the same metrics of salience, sentiment, confidence, co-references, disambiguation, and similarity against the entities or other metrics. As used herein, a prompt 107 can also be taken to mean a query, or other interaction with the system.

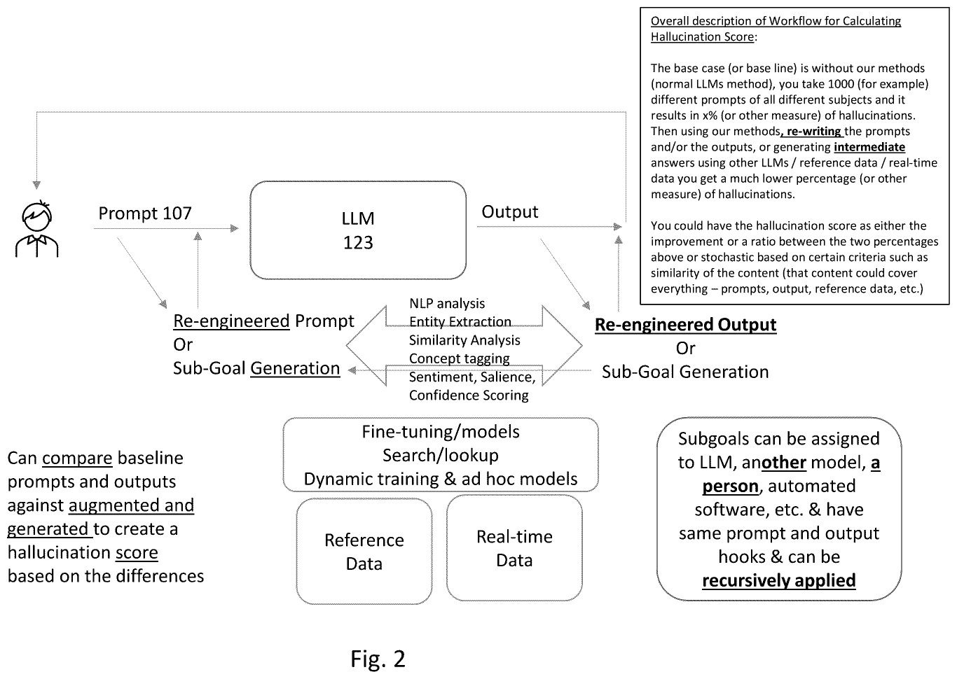

FIG. 2 illustrates another example systems for detecting hallucination as a metric for determining the accuracy of responses from a large language model, in accordance with various example implementations of this disclosure.

In this situation, the AI model 123 can create a sub-query to generate a dynamic, generative, a directed/focused training set (or a training set that is objectively more useful in other ways) based on the real-time data records and the reference data. The sub-query may be used to generate a small fine-tuning set to adjust the model with increased sample weights (the model will be penalized more heavily for making mistakes on this sample set compared to previous ones). The reason for a sub-query is because retraining is too slow. In this case, we would have a set of candidate records for a quick fine-tuning before directly answering the question.

The predicted discrepancy between the original prompt and the augmented regenerated prompt, the number of records relevant to the prompt that are not in the training set, and the conceptual similarity and closeness to known non-hallucinatory prompts and other similar queries may indicate how truthful an answer will be. This serves as the first part of the hallucination score.

Example questions for determining hallucination scores comprise, but are not limited to: “Are they valid companies?”, “Has there been any news or other information on this company and concept in the past week?” and “What events have had financial impacts or other impacts?”

In addition to rewriting sub-queries, the system may also generate sub-goals that attempt to come back with a definitive answer. The number of recursive calls may be limited by processing constraints and efficiency. Something like “I can try 1000 validation techniques to make sure I answer your question properly” . . . you always can but your system may be more tentative and/or less practical.

The base case (or base line) is without our methods (normal LLMs method), you take 1000 (for example) different prompts of all different subjects and it results in x % (or other measure) of hallucinations. Then using our methods, re-writing the prompts and/or the outputs, or generating intermediate answers using other LLMs/reference data/real-time data you get a much lower percentage (or other measure) of hallucinations.

You could have the hallucination score as either the improvement or a ratio between the two percentages above or stochastic based on certain criteria such as similarity of the content (that content could cover everything—prompts, output, reference data, etc.)

Take the example that Tesla is using Nvidia in their self-driving cars. At some point, they dropped support for Nvidia, but at a much more recent date, Tesla decided to support Nvidia in their AI cloud computing. A user query as to whether or not Tesla uses Nvidia could have multiple answers from an LLM that could easily be not true. The LLM will generate the most probable answer, but that answer is very different depending on the real-time data stream, and even worse, the usage of one by the other is in a completely different context than what the user may have been asking.

By way of example and not limitation, the disclosed method may determine that the two companies are entities, differentiate between electric vehicles and cloud computing, leverage the company metadata and hierarchies, check for the number of relationships in the real-time feed, and even generate an on-demand fine-tuning set from the data store query.

After a LLM has generated an answer, the NLP pipeline can perform the same function on the returned answer by cross-referencing all the different entities, tags, and values against the real-time data, the reference data, and other similarly-scored content. Like the prompt, this analysis of the result can determine, based on the scores and number of values, whether or not the answer is likely to be truthful. This makes up the second part of the hallucination score.

Being able to measure the salience or other quality(s) of these extracted items in the query or response and cross-check them against the real-time feed and reference data improves the quality of answers. When and if the real-time feed and reference data are needed may be determined by using the pre- and post-analysis. Similar to the statistical correlation of the “next likely word” in LLMs, the system provides conceptual likelihood using extracted concepts. The system also values what workflow steps are likely to solve the user's query/problem/question in a way that minimizes the hallucinations.

To ensure the veracity and relevance of answers generated by models, we have introduced a comprehensive evaluation system called Hallucination Score Criteria. The criteria incorporate both binary and continuous factors. Binary factors are converted into a composite score computed as the ratio of positive binary outcomes to their total count. Continuous values undergo a weighted averaging process based on each factor's significance. The resultant Hallucination Score offers a consolidated measure, representing a weighted average of these criteria groups, providing a holistic metric to measure the reliability of the model's responses. Here's a breakdown of the criteria groups and their components:

### Overall Description of Workflow for Calculating Hallucination Score Article-Level Criteria (Guided by LLM Sub-Queries)

Source Referenced: Evaluates the alignment of the model's answer with the cited source. Flag as ‘False’ when the reference doesn't corroborate the information provided. Factual Integrity: Scrutinizes the answer's objectivity. Flag as ‘False’ if any subjective or opinionated content is detected. Temporal Accuracy: Assesses the relevance of the answer in relation to the specified timeframe. Flag as ‘False’ when the answer misrepresents past events as present or speculatively addresses the future. Content Completeness: Gauges whether the answer provides all essential information from the source. Flag as ‘False’ if there's a lack of comprehensive data, even when the omission is acknowledged.

### Multi-Article Criteria

Similarity Score: Uses vector similarity techniques to compare the coherence of answers derived from analogous articles. Answer Comprehensiveness: Evaluates the aggregate data quality when sourcing answers from multiple articles. Consistency Analysis: Utilizes entity and relationship comparison methods to identify inconsistencies among answers from diverse sources.

### Time-Related Criteria

Recency Evaluation: Ensures the model's response mirrors the latest data or advancements. Historical Context: Assures that when relevant, the answer contextualizes information historically-useful when addressing queries like “last year”.

### Metadata Criteria

Entity Correlation: Enumerates how many entities in the question are mirrored in the model's answer. Co-reference Analysis: Ensures the model's response effectively correlates to all referenced entities in the query. Relationship Elucidation: Examines the answer's capacity to discern and expound upon inter-entity or topic relationships. KB Alignment: Cross-checks the model's answers against trusted knowledge bases to maintain factual consistency.

A pivotal component of this system is the Bitvore analyzer's ability to treat each model-generated answer as a record. This facilitates the extraction of metadata of the answers themselves, enabling robust entity and relationship comparisons, vectorization, and the elucidation of temporal contexts like “ . . . last year” using date-like entities (e.g. when these dates are used to form proper queries for source filtering).

By comparing the scores without the augmented system to the scores with the augmented system, the similarity or dissimilarity may be mapped into a hallucination score. That score can accurately predict when an answer is likely to be a hallucination. This is accomplished using similarity analysis on the text between un-altered responses and altered responses. For example, an un-altered hallucination response may include entities like companies, people, topics that aren't supported in the datastore. One simple metric is the similarity of the overall text, the salience (importance) of each entity compared to one versus the other, the per-mention sentiment of each entity or co-reference to an entity, and the existence or absence of entities in one result and not the other result. This discrepancy can be evaluated by a human or a machine learning model and the scores can be ranked and stored for future use.

This score can be shown to the user to warn them that the answer they might require additional research—yes, Tesla uses Nvidia, but only in their AI cloud, but they moved to a custom chip in their self-driving car hardware, here's the real-time excerpts that support this. The hallucination scores can also be used as internal indicators such that the system has to look for more recent information, more recent information is available, or that more data is needed.

The system may not know where to look for recent information, as the system may not be fine-tuned in everything all the time, because that is absurdly inefficient. The system would look for more recent content that is already filtered towards the tags and topics that are more likely to answer the initial question. The goal is to extract types of entities and metrics we know about and convert a prompt into a “premise” that is conceptually the same or similar, but with more effective results. For the Nvidia and Tesla example, you do not want all the Nvidia and Tesla articles, you may want them broken up into time periods, you may only want ones that mention partnership with the topic of self-driving and not datacenters, etc.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A computing system:
one or more processors;
a reference database; and
one or more non-transitory computer-readable media that collectively store instructions that, when executed by the one or more processors, cause the computing system to perform operations, the operations comprising:
receiving a prompt,
processing the prompt with an artificial intelligence (AI) model to generate a basis output,
generating a first plurality of metrics by comparing the basis output to the reference database according to a plurality of criterion,
extracting one or more entities from the prompt,
fine tuning the prompt according to one or more previous prompts associated with the one or more extracted entities,
processing the fine-tuned prompt with the AI model to generate an enhanced output,
generating a second plurality of metrics by comparing the enhanced output to the reference database according to the plurality of criterion, and
determining a hallucination score according to a comparison of the first plurality of metrics to the second plurality of metrics.

2. The computing system of claim 1, wherein the operations comprise:
rewriting the initial query to generate a new query;
processing the new query with the AI model to generate a new output,
generating a plurality of new metrics by comparing the new output to the reference database according to the plurality of criterion,
determining a new hallucination score according to a comparison of the first plurality of metrics to the new plurality of metrics.

3. The computing system of claim 2, wherein the new query is based on the hallucination score.

4. The computing system of claim 2, wherein the operations comprise:
iteratively performing the rewriting, the processing, the generating, and the determining until the hallucination score or the new hallucination score is acceptable.

5. The computing system of claim 3, wherein the hallucination score or the new hallucination score is acceptable as compared to a threshold.

6. The computing system of claim 1, wherein the operations comprise:
providing a user interface configured to receive a new query according to the hallucination score.

7. The computing system of claim 6, wherein the operations comprise:
processing the new query with the AI model to generate a new output,
generating a plurality of new metrics by comparing the new output to the reference database according to the plurality of criterion,
determining a new hallucination score according to an evaluation of the plurality of new metrics.

8. The computing system of claim 7, wherein the operations comprise:
iteratively performing the rewriting, the processing, the generating, and the determining until the hallucination score or the new hallucination score is acceptable.

9. The computing system of claim 8, wherein the hallucination score or the new hallucination score is acceptable as compared to a threshold.

10. The computing system of claim 1, wherein the operations comprise:
providing a user interface configured to allow a user to change the output according to the hallucination score.

11. The computing system of claim 10, wherein the operations comprise:
generating a new query according to the hallucination score and the changed output.

12. The computing system of claim 11, wherein the operations comprise:
processing the new query with the AI model to generate a new output,
generating a plurality of new metrics by comparing the new output to the reference database according to the plurality of criterion,
determining a new hallucination score according to an evaluation of the plurality of new metrics.

13. The computing system of claim 12, wherein the operations comprise:
iteratively performing the rewriting, the processing, the generating, and the determining until the hallucination score or the new hallucination score is acceptable.

14. The computing system of claim 13, wherein the hallucination score or the new hallucination score is acceptable as compared to a threshold.

15. The computing system of claim 1, wherein the AI model is a large language model (LLM).

16. The computing system of claim 1, wherein the reference database comprises is a real-time content feed.

17. A computing system:
one or more processors;
a first reference database; and
one or more non-transitory computer-readable media that collectively store instructions that, when executed by the one or more processors, cause the computing system to perform operations, the operations comprising:
receiving a prompt,
processing the prompt with an artificial intelligence (AI) model to generate a first output,
inputting the first output into a system which contains a large language model (LLM) to generate a second output,
extracting one or more entities from the prompt,
cross-validating the second output according to one or more previous output associated with the one or more extracted entities,
determining a hallucination score according to the cross validation.

18. The computing system of claim 1, wherein the operations comprise:
generating a plurality of metrics by comparing the second output to a reference database according to a plurality of criterion, and
determining a new hallucination score according to an evaluation of the plurality of metrics.
